(19) United States
(12) Patent Application Publication
(10) Pub. No.: US 2022/0210189 A1
(43) Pub. Date: Jun. 30, 2022

(54) MITIGATION OF PHISHING RISK

(71) Applicant: COMMONWEALTH SCIENTIFIC AND INDUSTRIAL RESEARCH ORGANISATION, Australian Capital Territory (AU)

(72) Inventors: Kun YU, Australian Capital Territory (AU); Fang CHEN, Australian Capital Territory (AU)

(73) Assignee: COMMONWEALTH SCIENTIFIC AND INDUSTRIAL RESEARCH ORGANISATION, Australian Capital Territory (AU)

(21) Appl. No.: 17/605,918

(22) PCT Filed: Apr. 23, 2020
(86) PCT No.: PCT/AU2020/050394

§ 371 Date: Oct. 22, 2021

(30) Foreign Application Priority Data
Apr. 23, 2019 (AU) 2019901385

(51) Int. Cl. H04L 9/40; H04L 41/16

(52) U.S. Cl. CPC H04L 63/1483; H04L 41/16; H04L 63/20; H04L 63/1433

(57) ABSTRACT

There is disclosed a method for mitigating phishing risk to a recipient of a phishing electronic document. The method comprises receiving (302) the phishing electronic document (108) intended for the recipient (104) and identifying (304) parameters in the phishing electronic document. The parameters are applied (306) to a customised risk profile of the recipient to generate a risk index. The risk index is then compared (308) to a specified risk threshold. A phishing alert based on the comparison is generated (310) and provided (312) to the recipient along with the electronic document.

### CROSS-REFERENCE TO RELATED APPLICATIONS

The present application claims priority from Australian Provisional Patent Application No 2019901385 filed on 23 Apr. 2019, the contents of which are incorporated herein by reference in their entirety.

### TECHNICAL FIELD

This disclosure relates to systems and methods for mitigating phishing risk and in particular to customised mitigation of phishing risk.

### BACKGROUND

Phishing refers to a fraudulent activity performed through computerised communication systems. The aim of the activity is obtain private information from a user of the communication, such as user names and passwords, banking details, credit card details etc.

Phishing is typically based on fraudulent communications which appear to originate from a trusted source, such as a bank, but which are in fact being sent by a criminal organisation. The fraudulent communication presents a scenario which requires the user to provide the private information. The user unwittingly provides the information to the criminal organisation believing it is being required or requested by the trusted source.

### SUMMARY

According to a first aspect, there is provided a method for mitigating phishing risk to a recipient of a phishing electronic document, the method comprising:
receiving the phishing electronic document intended for the recipient;
identifying parameters in the phishing electronic document;
applying the parameters to a customised risk profile of the recipient to generate a risk index;
comparing the risk index to a specified risk threshold;
generating a phishing alert based on the result of comparing the risk index to the specified risk threshold; and
providing the electronic document to the recipient with the phishing alert.

It is an advantage of this embodiment that customised phishing alerts can be generated for a specific user based on that user's risk profile. The customised alerts take into consideration the user's understanding of, and history with, phishing messages before generating the alert and thereby avoid generating unnecessary alerts.

According to a second aspect there is provided a method for mitigating phishing risk to a recipient of a phishing electronic document, the method comprising:
receiving the phishing electronic document intended for the recipient;
identifying parameters in the phishing electronic document;
providing the phishing electronic document to the recipient;
receiving, from one or more sensors, recipient interaction data based on the recipient's interaction with the parameters;
applying the parameters and interaction data to a customised risk profile of the recipient to generate a risk index;
comparing the risk index to a specified risk threshold;
generating a phishing alert based on the result of comparing the risk index to the specified risk threshold; and
providing the phishing alert to the recipient.

It is an advantage of this embodiment that customised phishing alerts can be generated for a specific user based on that user's risk profile. The customised alerts take into consideration the user's interaction with parameters and features in the phishing message and make a prediction of the user's decisions based on their history and current interaction data to thereby avoid generating unnecessary alerts.

The recipient interaction data may comprise one or more of mouse movement, keyboard usage and response time.

The recipient interaction data may comprise eye movement.

The parameters may include an embedded URL link and a topic.

The parameters may further include document category, key word and/or address.

The risk index may comprise a predicted decision of the recipient.

The risk index may comprise a probability of the recipient activating a URL.

The method may further comprise the step of providing customised training to the recipient.

The customised risk profile for the recipient may be generated by:

sending, to the recipient, a plurality of different electronic training documents of a first type and a plurality of different training electronic documents of a second type, wherein the documents of the first type include phishing parameters and the documents of the second type include non-phishing parameters;

receiving, from one or more sensors, recipient training interaction data based on the recipient's interaction with the phishing parameters and the non-phishing parameters; and

generating the customised risk profile using a machine learning algorithm operating on the recipient training interaction data and the phishing parameters and the non-phishing parameters.

The plurality of electronic training documents of the first type and the second type may be randomly selected for sending to the recipient.

The recipient training interaction data may further comprise recipient decision data.

The recipient interaction data may comprise one or more of mouse movement, keyboard usage, response time, eye movement and face movement.

The machine learning algorithm may be a neural network.

The machine learning algorithm may be a hidden Markov model.

The machine learning algorithm may be a support vector machine.

According to a third aspect there is provided a system for mitigating phishing risk to a recipient of a phishing electronic document, the system comprising:
a memory module for storing a customised risk profile of the recipient; and
a processor configured to:
   receive the phishing electronic document intended for the recipient;
   identify parameters in the phishing electronic document;
   apply the parameters to the customised risk profile of the recipient to generate a risk index;
   compare the risk index to a specified risk threshold;
where the risk index exceeds the specified threshold, generate a phishing alert; and
provide the electronic document to the recipient with the phishing alert.

According to fourth aspect there is provided a non-transitory computer readable medium configured to store the software instructions that when executed cause a processor to perform the method of aspect one or aspect two.

According to a fifth aspect there is provided a device for mitigating phishing risk to a recipient of a phishing electronic document, the device comprising:
a processor configured to:

receive the phishing electronic document intended for the recipient;

identify parameters in the phishing electronic document;

apply the parameters to a customised risk profile of the recipient to generate a risk index;

compare the risk index to a specified risk threshold;
where the risk index exceeds the specified threshold, generate a phishing alert; and
provide the electronic document to the recipient with the phishing alert.

### BRIEF DESCRIPTION OF DRAWINGS

FIG. 1 is a schematic illustration of a system for mitigating phishing risk;

FIG. 2 is a schematic illustration of a phishing mitigation module;

FIG. 3 is a flow diagram for a method for mitigating phishing risk;

FIG. 4 is a flow diagram for a method for mitigating phishing risk;

FIG. 5 is a schematic illustration of a server based system for mitigating phishing risk;

FIG. 6 is a flow diagram for a method for generating a customised risk profile;

FIG. 7 is an exemplary phishing message;

FIG. 8 is a schematic illustration of a machine learning system used to generate a customised risk profile; and

FIG. 9 is a schematic illustration of a phishing mitigation module.

### DESCRIPTION OF EMBODIMENTS

Due to the increasing number of on-line services and greater reliance on electronic communications, phishing has become an ever growing problem. Typically, anti-phishing measures rely on the user's ability to identify valid communications or on the user's vigilance in confirming the authenticity of an electronic document received as part of a communication.

Although automated systems exist for detecting phishing communications, they are not entirely accurate in their identification and may produce false identifications. Therefore, it is not suitable to simply remove phishing communications with the automated systems as many genuine communications could inadvertently be removed.

Accordingly, some systems will attach a warning message to communications identified as risky, allowing the recipient of the communication to analyse the communication for authenticity. However, if a recipient receives an excessive number of warnings, the vigilance of that recipient begins to wane, reducing the efficacy of the warnings.

### Overview

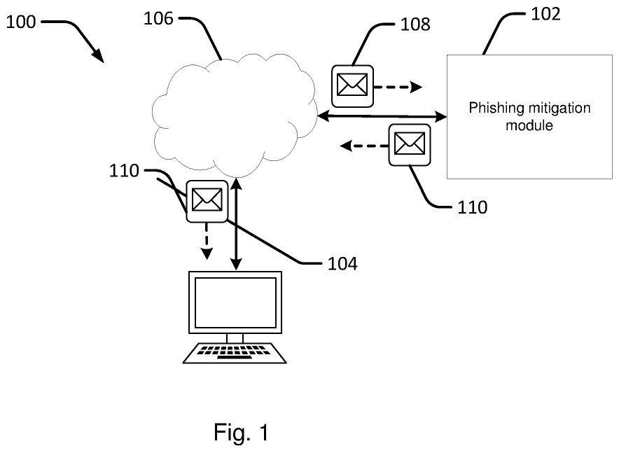

Referring initially to FIG. 1, a system 100 for mitigating phishing risk to a user accessing an electronic document is described. The electronic document has already been identified as a potential phishing document and hence these terms will be used interchangeably.

Embodiments will be described with reference to mitigating phishing risk when accessing emails. However, it will be appreciated that embodiments to other applications are also included such as short message service (SMS) messages or other electronic message format.

System 100 comprises a phishing mitigation module 102 and a client device 104 where a user accesses the electronic document or message. Module 102 and client device 104 are in communication over network 106. Module 102 receives a phishing message 108 through network 106 with the intended recipient being a user of client device 104. Module 102 identifies parameters of message 108 and applies them to a customised risk profile of the recipient. The customised risk profile receives the parameters as an input and produces a risk index. The risk index is then compared to a specified risk threshold and an alert message generated based on the result of the comparison. For example, in some embodiments where the risk index exceeds the risk threshold a phishing alert is generated. Module 102 then provides a combined message 110 to the user of client device 104 through network 106. Combined message 110 comprises phishing message 108 and the phishing alert.

In the case where the risk index does not exceed the risk threshold, no alert message is generated and combined message 110 is the same as phishing message 108.

In some embodiment, the specified risk threshold defines ranges and the nature of the alert message generated is dependent on which band the risk index falls into. For example, the ranges may define a low-risk range, a medium-risk range and a high-risk range. The specifics of the alert message will be dependent on which range the risk index falls within, with higher risk ranges causing alerts with stronger wording and/or more obvious visibility such as a large pop-up message.

It will be appreciated that the specified risk threshold determines the sensitivity of system 100 to phishing messages.

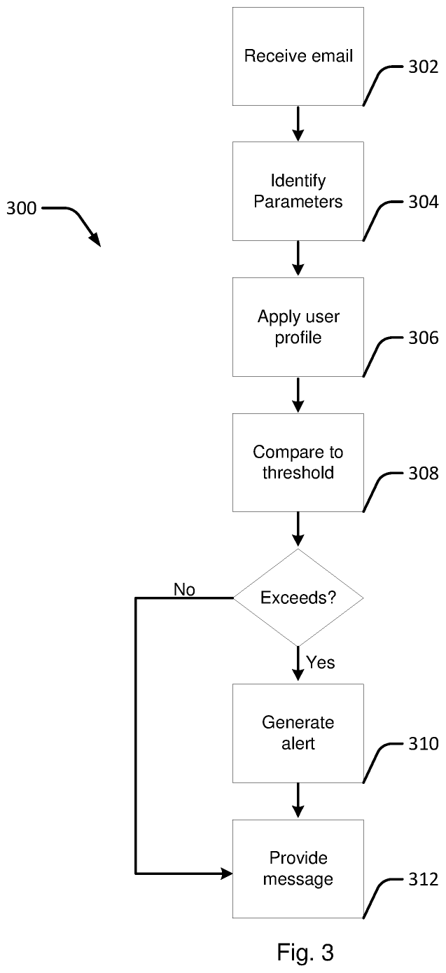

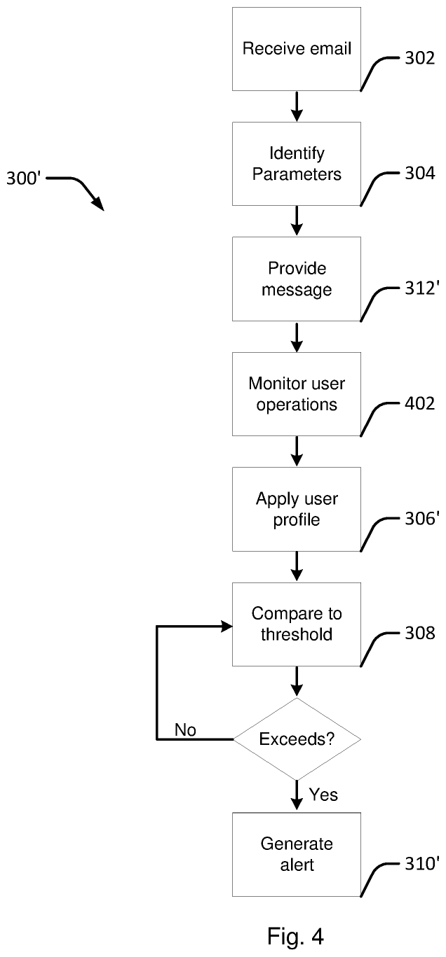

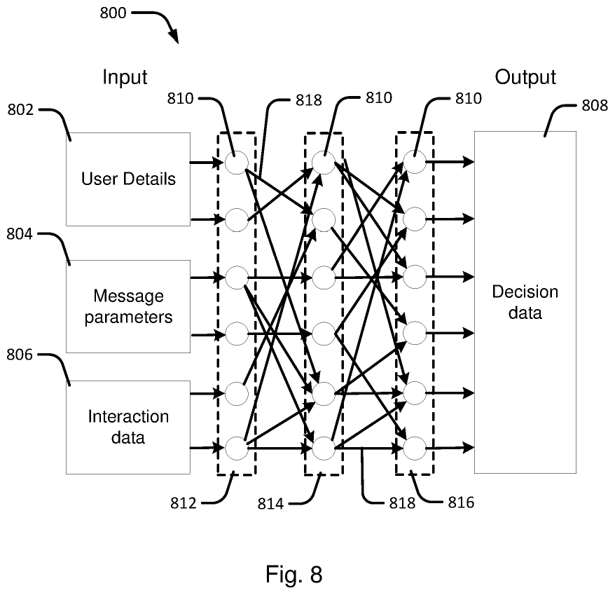

The nature of the customised risk profile and how it is generated is described in detail below with reference to FIG. 8. Similarly, the method performed by module 102 will be described in greater detail below with reference to FIGS. 3 and 4.

In some embodiments, network 106 is a direct connection between module 102 and client device 104. For example, module 102 may be located within client device 104, having a direct or indirect internal connection, or connected to it through a wired local area network (LAN). In other embodiments, network 106 may be a wireless connection employing a wireless communication protocol such as WiFi. In other embodiments, network 106 may be a packet network such as a 3G, 4G or 5G communication network.

As mentioned above, phishing message 108 is identified as a phishing message by an automated system for detecting phishing communications. This system may reside on a messaging server such as an email server analysing all electronic documents or messages passing through that server. When a suspected phishing message is detected, it is diverted to phishing mitigation module 102 through a communication channel. In some embodiments, phishing mitigation module 102 is housed within the messaging server and the communication channel is a direct or indirect internal connection. In other embodiments, phishing mitigation module 102 and the messaging server are separate devices and the communication channel can be any suitable communication channel. For example, the communication channel could be the Internet, a packet network such as a 3G, 4G or 5G communication network or some other communications network (such as WAN, LAN or WLAN). This system for detecting phishing communications is not illustrated for reasons of clarity.

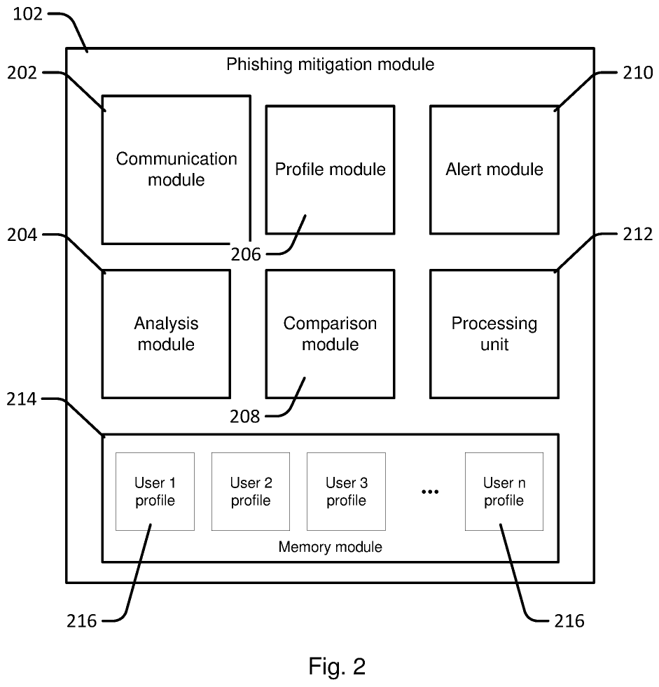

Phishing mitigation module 102 is illustrated schematically in FIG. 2. Module 102 comprises a communication module 202, an analysis module 204, a profile module 206, a comparison module 208, and alert module 210, a processing unit 212 and a memory module 214 for storing customised risk profiles 216 for one or more users/recipients.

The method performed by modules of phishing mitigation module 102 is executed by processing unit 212. Processing unit 212 may comprise a single computer processor configured to execute the methods as described below or may comprise a plurality of computer processors working in conjunction to execute the methods described below.

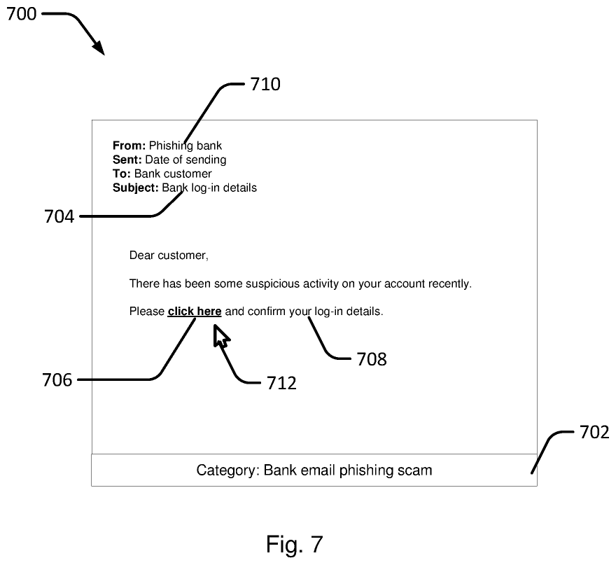

The method performed by phishing mitigation module 102 is illustrated as method 300 of FIG. 3. At step 302, communication module 202 receives phishing message 108. Phishing message 108 is then processed by analysis module 204 to identify pertinent parameters of message 108 in accordance with step 304 of method 300. The pertinent parameters are discussed in greater detail below with reference to FIG. 7, but in brief comprise one or more of an embedded uniform resource locator (URL), a message topic, a document category, a key word or an address. The intended recipient of message 108 is also identified.

Profile module 206 receives the parameters from analysis module 204 and performs step 306 by applying the parameters to a customised risk profile 216′ of the identified intended recipient of message 108. Customised risk profile 216′ is a decision model for that particular recipient/user. The generation of the model is described in greater detail below with reference to FIG. 8. A customised risk profile 216 receives message parameters as an input and generates a risk index for that particular user/recipient based on the message parameters. The risk index is a measure of how susceptible a particular user may be to the parameters of phishing message 108.

Step 308 is then performed by comparison module 208, which receives the risk index from profile module 206. Comparison module 208 compares the risk index to a specified risk threshold and an alert message generated based on the result of the comparison. For example, in some embodiments where the risk index exceeds the specified risk threshold, alert module 210 performs step 310 and generates an alert for the user. The alert is sent to the intended recipient, along with phishing message 108, as message 110 through communication module 202. The intended recipient receives message 110 at client device 104. The alert, received with message 110, helps expose a potential risk in message 108 to the user, thereby mitigating the phishing risk of message 108.

In the case where the risk index does not exceed the specified risk threshold, communication module 202 performs step 312 by providing message 108 to client device 104 without an alert. In this case, potential phishing risk of message 108 to that particular recipient is deemed low since the risk index is below the specified risk threshold. Typically, this occurs where a particular user has demonstrated awareness and vigilance to the particular risk presented by phishing message 108. The user is therefore not provided with an alert.

In some embodiment, the specified risk threshold defines ranges and the nature of the alert message generated is dependent on which band the risk index falls into or whether it falls outside of the specified risk threshold range.

In some embodiments, phishing mitigation module 102 performs method 300′ of FIG. 4 instead of method 300 of FIG. 3. Method 300′ is similar to method 300 and comprises many of the same steps which are identified by having the same reference numerals. The details of steps common to both method 300 and method 300′ will not be described again.

Initially, in method 300′, steps 302 and 304 are performed before step 312′. At step 312′, phishing message 108 is provided to the intended recipient as message 110. Message 110 is provided by communication module 202 to the intended recipient at client device 104 through network 106. Message 110 does not include an alert.

When message 110 is accessed by the intended recipient at client device 104, profile module 206 performs steps 402 and 306′. At step 402 the operations of the user of device 104 are monitored. These operations include interaction data of the user interacting with message 110 such as mouse cursor movements, keyboard usage, eye movement, face movements and response time. These user operations are used by profile module 206, in conjunction with the message parameters determined at step 304, to generate a risk index. The interaction data is collected by one or more sensors attached to client device 104 and are provided to phishing mitigation module 102 via network 106. Phishing mitigation module 102 receives the user operations through communication module 202. The user operations are updated as the user continues to view and interact with message 110.

It will be appreciated that the generated risk index updates as the interaction data is received by phishing mitigation module 102. Comparison module 208 performs step 308 as before, comparing the risk index to a specified risk threshold and an alert message generated based on the result of the comparison. For example in some embodiments, where the risk index exceeds the specified risk threshold, alert module 210 performs step 310′, generating an alert and providing it to the user at client device 204. The alert message is provided by communication module 202 through network 106.

In the case where the risk index does not exceed the specified risk threshold, method 300′ takes no action and continues to perform step 308.

In some embodiment, the specified risk threshold defines ranges and the nature of the alert message generated is dependent on which band the risk index falls into as described above.

It will be appreciated that methods 300 and 300′ allows for alerts to be generated for a user based on the user's understanding and vigilance with regards to phishing messages. This prevents the situation where a user's vigilance begins to wane due to excessive alert messages.

### Generalised Client Server Framework

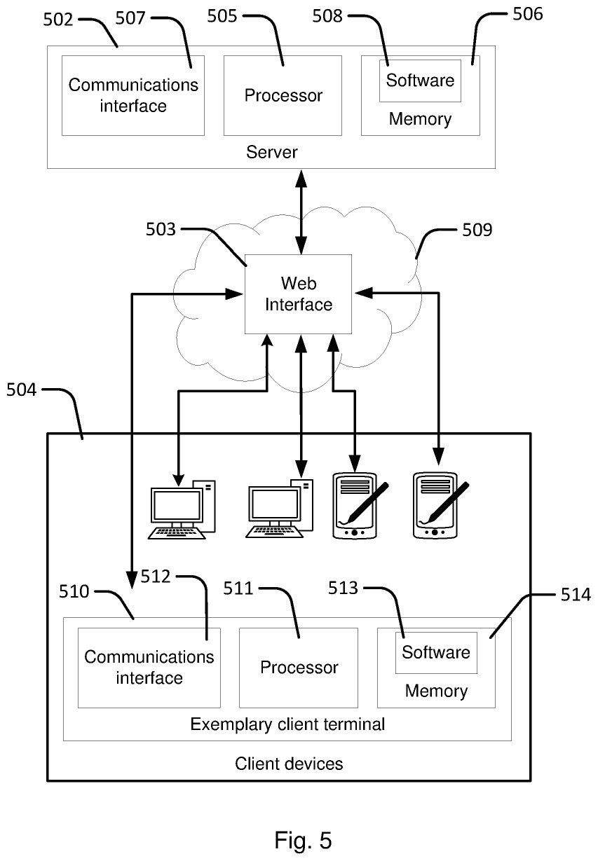

In some embodiments, methods and functionalities considered herein are implemented by way of a server, as illustrated in FIG. 5. In overview, a web server 502 provides a web interface 503. This web interface is accessed by the users by way of client terminals 504. In overview, users access interface 503 over network 509 by way of client terminals 504, which in various embodiments include the likes of personal computers, PDAs, cellular telephones, gaming consoles, and other Internet enabled devices.

Server 503 includes a processor 505 coupled to a memory module 506 and a communications interface 507, such as an Internet connection, modem, Ethernet port, wireless network card, serial port, or the like. In other embodiments distributed resources are used. For example, in one embodiment server 502 includes a plurality of distributed servers having respective storage, processing and communications resources. Memory module 506 includes software instructions 508, which are executable on processor 505. Software instructions 508 include instructions to perform methods 300 and/or 300′. Memory module 506 may also comprise memory module 214 of phishing mitigation module 102.

In some embodiments web interface 503 includes a website. The term “website” should be read broadly to cover substantially any source of information accessible over the Internet or another communications network 509 (such as WAN, LAN or WLAN) via a browser application running on a client terminal. In some embodiments, a website is a source of electronic messages made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

In general terms, each terminal 504 includes a processor 511 coupled to a memory module 513 and a communications interface 512, such as an intemet connection, modem, Ethernet port, serial port, or the like. Memory module 513 includes software instructions 514, which are executable on processor 511. These software instructions allow terminal 504 to execute a software application, such as a proprietary application or web browser application and thereby render on-screen a user interface and allow communication with server 502. This user interface allows for the creation, viewing and administration of profiles, access to electronic messages, and various other functionalities. Alert messages generated by server 502 at step 310 and 310′ of methods 300 and 300′ are provided to users of client terminals 504 through this user interface.

### Generating the Decision Model

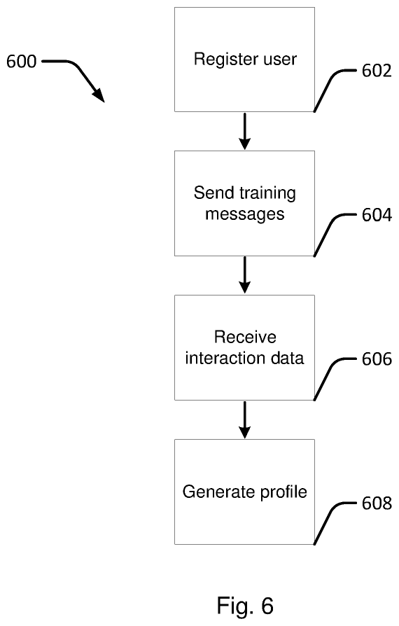

A method for generating customised risk profile 216 for a particular user is illustrated as method 600 of FIG. 6. As mentioned above, customised risk profile 216 is a decision model for a given recipient/user.

Initially, at step 602, the user for which the risk profile will be generated is registered. This step involves collecting information about the user for purposes of identification. In some embodiments, step 602 further comprises accessing a previous risk profile for that user.

At step 604, a plurality of electronic training messages are sent to the user. The user accesses the messages using a client terminal. In some embodiments, the client terminal is the same as client device 104 while in other embodiments it is a dedicated training client terminal. The plurality of electronic training messages comprises a plurality of messages of a first type and a plurality of messages of a second type. The messages of the first type comprise phishing parameters while the messages of the second type comprise non-phishing parameters. An exemplary email message 700 of the first type is illustrated in FIG. 7.

The phishing parameters comprise one or more of: a document category 702, a topic 704, embedded uniform resource locator 706 (URL), a key word or phrase 708 and/or an address 710.

Other phishing parameters, not illustrated for clarity, may also be considered. For example, in some embodiments, the phishing parameters further comprise one or more of: the time that the message was sent, the receiver information such as whether the message was sent to a group or an individual, and whether the message included graphics or multimedia.

Document category 702 of message 700 relates to a classification of message 700 into one or more predetermined categories. In the present example, the category is a bank related email phishing scam. Other examples of categories include: bank telephone scams, prize phishing, parcel delivery phishing, SMS banking phishing, tax office phishing, etc. For the purposes of method 600, document category 702 appears in the metadata of message 700 and is not visible to the user.

Topic 704 of message 700 relates to the more specific details of phishing message 700. In the present example, topic 704 specifies that message 700 relates to a banking scam attempting to obtain the user's login-in details. Other examples of topics include: bank telephone scams where a user is enticed to phone a phisher's number and provide sensitive information (such as credit card details and/or account details), prize phishing where a user is told they have won a prize and must provide sensitive information or pay some fees to receive it, parcel delivery phishing where a user is told they have a parcel to be delivered and must provide sensitive information and/or pay some fees to receive it, SMS banking phishing where a user receives an SMS encouraging them to provide sensitive information, tax office phishing where a user receives a message requesting payment of a tax debt, etc. In many cases, the topic of message 700 can be determined from one or more words in message 700, although this does not necessarily make it obvious that message 700 is a phishing message. Topic 704 is included in metadata of message 700 and is not directly visible to the user although the words from which it is determined may be.

URL 706 is an embedded link in message 700. The contents of message 700 is designed to entice the user to click the URL with cursor 712 which will provide the user access to the phishing operator's website. The phishing operators website will ask the user for sensitive information such as bank login-in details, credit card details etc.

Key word or phrase 708 relates to use of certain specific words in message 700 which may influence the user. For example, in the present example the term “confirm your log-in details” is a key word or phrase 708. Key words 708 can be used to identify phishing messages but may also mislead the user/recipient of the message. In many situations, key word 708 is dependent on document category 702 and topic 704. For example, there is little reason that a bank would require a user to confirm log-in details.

Address 710 can refer to the source of message 700. This may be a digital location such a website or a physical location. Address 710, in conjunction with other information in message 700 can be an indicator of a phishing message. For example, address 710 may indicate that the source of message 700 is in a foreign country. Similarly, if URL 706 provides a link to a site that does not match address 710 then there is a heightened possibility that message 700 is a phishing message.

Returning to method 600 of FIG. 6, user training interaction data is received at step 606. The training interaction data is collected by one or more sensors at the client terminal on which the user is receiving message 700. The training interaction data relates to that specific user's reactions to the message parameters and includes mouse cursor/hand movement captured by a mouse cursor tracker, eye movement and/or face movements captured by a camera, keyboard strokes captured by keyboard typing recorder, and reaction times. The user interaction data provides an indication as to how critically the user is considering message 700.

The training interaction data further comprises recipient decision data. The decision data relates to the recipient's decision; that is, whether they were deceived by the phishing message, deleted it or reported it to an IT or data security department.

At step 608, the customised user risk profile, or decision model, is generated. The decision model is generated using a machine learning algorithm such as the three-layer neural network 800 illustrated in FIG. 8. In some embodiments, other machine learning models are used to generate the decision model. For example, in some embodiments a hidden Markov model is used. In other embodiments, a support vector machine is used to generate the decision model.

Neural network 800 receives, as input, user data 802 received at step 602, message parameters 804 received at step 604 and the user interaction data 806 received at step 606. During a training phase, decision data 808 is used as the output and the decision model developed by a standard neural network training procedure. For example, in some embodiments back propagation is used to train the decision model. That is each node in a given layer 812 to 816 receives input from nodes in a previous layer and outputs some non-linear function of the sum of its inputs. The output of the final layer is compared to decision data 808 and the weightings of each connection 818 adjusted until the output of final layer 816 matches output data 808. The nodes, with the weightings, then define the decision model for that particular user.

The decision model can then be used as the user profile in methods 300 and 300′. As mentioned above, other machine learning methods can also be used and this disclosure is not intended to be limited to artificial neural networks or to use of backpropagation in artificial neural networks.

It will be appreciated that the decision model is a customised risk profile for a given user, helping to predict a particular user's vulnerability to a particular phishing message. For example, consider a given user who is very alert to bank related phishing messages but less alert to parcel delivery phishing messages. Method 300 or 300′, using the decision model above, could selectively allow phishing emails with the parcel delivery topics to go through to that user along with a pop up alert. The alert may appear when the user accesses the message or before interaction data indicates that the user is about to click the URL. In many cases, no alert will be generated for that user for banking phishing messages.

It will further be appreciated that the customised risk profile and customised alert messages can serve as targeted training for a user to increase vigilance with respect to phishing messages.

Similarly, customised training can be developed for a user based on their risk profile. In some embodiments, the customized training comprises providing emails with customised behavioural features to improve the phishing awareness of the user. For example, if a user routinely hovers mouse cursor 712 over keywords 708 such as ‘bargain’, ‘offer’, ‘awards’ etc. before clicking URL 706, then training messages with these words will be sent to this user. When the training interaction data indicates that cursor 712 is hovering around these key words, an alert message will be generated for the user. For example, an alert message reading “please consider carefully before clicking the URL” may be generated for the user. Over time, the user's phishing awareness against such incoming suspicious messages will improve.

### Updating the Decision Model

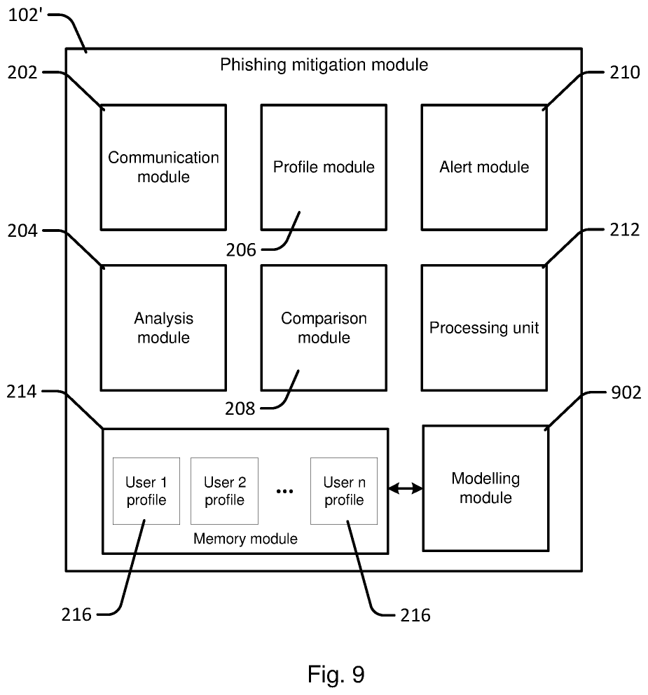

Another embodiment of phishing mitigation module 102 is shown as phishing mitigation module 102′ in FIG. 9. Phishing mitigation module 102′ is similar to module 102 but further comprises a modelling module 902.

Modelling module 902 updates a specific user's profile 216 as that user continues to view and interact with electronic messages. That is, that user's risk profile continues to be updated after it was initially generated at step 608 of method 600. So, for example, if a new type of phishing message were to be developed and the user received such a phishing message, that user's risk profile will be updated to include the user's interaction and decision data for the new phishing message. Similarly, if a user's vigilance with respect to a type of phishing message begins to wane, that user's risk profile will be updated such that it becomes more likely that an alert message will be generated for that user when receiving that type of phishing message.

It can therefore be considered that modelling module 902 helps to keep user profiles 216 current to new phishing messages and new user behaviours.

In some embodiments, the specified risk threshold is dynamic and may depend on the parameters of message 108. For example, the threshold may depend on the message category as messages in some categories may be considered higher risk than messages of other categories.

In some embodiments, the specified risk threshold may depend on recent interaction data of the user. For example, if recent interaction data indicates that the user's behaviour is becoming riskier, the specified risk threshold may be adjusted to make system 100 more sensitive and to therefore more readily generate alert messages. Conversely, if a user is demonstrating greater awareness of phishing messages, the risk threshold may be adjusted to reduce sensitivity and therefore be less likely to generate unnecessary alert messages.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for mitigating phishing risk to a recipient of a phishing electronic document, the method comprising:
receiving the phishing electronic document intended for the recipient;
identifying parameters in the phishing electronic document;
applying the parameters to a customised risk profile of the recipient to generate a risk index;
comparing the risk index to a specified risk threshold;
generating a phishing alert based on the result of comparing the risk index to the specified risk threshold; and
providing the electronic document to the recipient with the phishing alert.

2. A method for mitigating phishing risk to a recipient of a phishing electronic document, the method comprising:
receiving the phishing electronic document intended for the recipient;
identifying parameters in the phishing electronic document;
providing the phishing electronic document to the recipient;
receiving, from one or more sensors, recipient interaction data based on the recipient's interaction with the parameters;
applying the parameters and interaction data to a customised risk profile of the recipient to generate a risk index;
comparing the risk index to a specified risk threshold;
generating a phishing alert based on the result of comparing the risk index to the specified risk threshold; and
providing the phishing alert to the recipient.

3. The method of claim 2 wherein the recipient interaction data comprises one or more of mouse movement, keyboard usage and response time.

4. The method of claim 2 wherein the recipient interaction data comprises eye movement.

5. The method of claim 1 wherein the parameters include an embedded URL link and a topic.

6. The method of claim 1 wherein the parameters further include document category, key word and/or address.

7. The method of claim 1 wherein the risk index comprises a predicted decision of the recipient.

8. The method of claim 1 wherein the risk index comprises a probability of the recipient activating a URL.

9. The method of claim 1 further comprising the step of providing customised training to the recipient.

10. The method of claim 1 wherein the customised risk profile for the recipient is generated by:
sending, to the recipient, a plurality of different electronic training documents of a first type and a plurality of different training electronic documents of a second type, wherein the documents of the first type include phishing parameters and the documents of the second type include non-phishing parameters;
receiving, from one or more sensors, recipient training interaction data based on the recipient's interaction with the phishing parameters and the non-phishing parameters; and
generating the customised risk profile using a machine learning algorithm operating on the recipient training interaction data and the phishing parameters and the non-phishing parameters.

11. The method of claim 10 wherein the plurality of electronic training documents of the first type and the second type are randomly selected for sending to the recipient.

12. The method of claim 10 wherein the recipient training interaction data further comprises recipient decision data.

13. The method of claim 12 wherein the recipient interaction data comprises one or more of mouse movement, keyboard usage, response time, eye movement and face movement.

14. The method of claim 10 wherein the machine learning algorithm is a neural network.

15. The method of claim 10 wherein the machine learning algorithm is a hidden Markov model.

16. The method of claim 10 wherein the machine learning algorithm is a support vector machine.

17. A system for mitigating phishing risk to a recipient of a phishing electronic document, the system comprising:
a memory module for storing a customised risk profile of the recipient; and
a processor configured to:
receive the phishing electronic document intended for the recipient;
identify parameters in the phishing electronic document;
apply the parameters to the customised risk profile of the recipient to generate a risk index;
compare the risk index to a specified risk threshold;
where the risk index exceeds the specified threshold, generate a phishing alert; and
provide the electronic document to the recipient with the phishing alert.

18. A non-transitory computer readable medium configured to store the software instructions that when executed cause a processor to perform the method of claim 1.

19. A device for mitigating phishing risk to a recipient of a phishing electronic document, the device comprising:
a processor configured to:
receive the phishing electronic document intended for the recipient;
identify parameters in the phishing electronic document;
apply the parameters to a customised risk profile of the recipient to generate a risk index;
compare the risk index to a specified risk threshold;
where the risk index exceeds the specified threshold, generate a phishing alert; and
provide the electronic document to the recipient with the phishing alert.
